(19) United States
(12) Patent Application Publication
(10) Pub. No.: US 2004/0003155 A1
(43) Pub. Date: Jan. 1, 2004

(54) Method and system of indicating current operating speeds of expansion slots of a computer system

(75) Inventor: Jeoff M. Krontz, Tomball, TX (US)

Correspondence Address: HEWLETT-PACKARD COMPANY, INTELLECTUAL PROPERTY ADMINISTRATION, P.O. BOX 272400, FORT COLLINS, CO, 80527-2400, US

(73) Assignee: Compaq Information Technologies Group, L.P. a Delaware corporation, Houston, TX

(21) Appl. No.: 10/186,603

(22) Filed: Jul. 1, 2002

(51) Int. Cl. G06F 13/00

(52) U.S. Cl. 710/300

(57) ABSTRACT

A computer system is adapted for indicating current operating speeds of a plurality of expansion slots. The computer system includes a set of expansion slot speed indicators to indicate the current operating speeds.

### CROSS-REFERENCE TO RELATED APPLICATIONS

Not Applicable.

### STATEMENTS REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention generally relates to expansion slots of computer systems and more particularly to a method and system of indicating current operating speeds for such expansion slots.

2. Description of the Related Art

Most computer systems today utilize Peripheral Component Interconnect (PCI) buses and/or Peripheral Component Interconnect X (PCI-X) buses as input/output expansion buses. Several types of PCI buses and PCI-X buses are currently available: 32-bit 33 MHz PCI, 64-bit 33 MHz PCI, 64-bit 66 MHz PCI, 64-bit 100 MHz PCI-X and 64-bit 133 MHz PCI-X, for example. PCI/PCI-X is used herein to reference PCI and/or PCI-X. With each product generation, PCI/PCI-X bus architectures are becoming more complicated. For instance, PCI/PCI-X buses may be shared by different types of PCI/PCI-X adapter cards and by multiple PCI/PCI-X slots. Further, computer systems are appearing with more and more PCI/PCI-X buses and slots. PCI Hot Plug technology adds yet another degree of complexity. An additional factor is that many users are not accustomed to PCI-X technology, which is relatively new as compared to PCI technology. For these sorts of reasons, it is not uncommon for a computer system to be populated with PCI/PCI-X adapter cards in an unintended manner that reduces system performance.

One example of performance degradation is where a 66 MHz PCI adapter card and a 100 MHz PCI-X adapter card are on the same expansion bus such as a 100 MHz PCI-X bus. In this circumstance, the expansion bus will be running at the slower 66 MHz speed. This reduces the performance of the 100 MHz PCI-X adapter card. This performance loss can be avoided by providing the 66 MHz PCI adapter card and the 100 MHz PCI-X adapter card on different expansion buses. A user however may be unaware that the 66 MHz PCI adapter card and the 100 MHz PCI-X adapter card are on the same expansion bus. Even worse, the user may be unaware of the performance issue altogether.

Another example of performance degradation is where a particular PCI/PCI-X adapter card is running at the wrong speed due to some form of failure. Such a performance issue is often difficult for a user to detect. No doubt there are various other performance degradation scenarios in which a user may be confused about PCI/PCI-X adapter cards.

### BRIEF SUMMARY OF THE INVENTION

Briefly, in one exemplary embodiment, a computer system includes a processor, a plurality of expansion slots coupled to the processor, a speed detector to detect the current operating speeds of the plurality of expansion slots and a set of expansion slot speed indicators to indicate the current operating speeds.

In another exemplary embodiment, a method includes detecting a current operating speed of an expansion slot of a computer system and indicating the current operating speed at a location proximate to the expansion slot.

In a further exemplary embodiment, a system includes a means for detecting a current operating speed of an expansion slot of a backplane of a computer system, a means for generating an expansion slot operating speed signal based on the current operating speed and a means for providing the expansion slot operating speed signal to the backplane.

In an additional exemplary embodiment, a system includes a set of expansion slot speed indicators to indicate a current operating speed of each expansion slot of a plurality of expansion slots of a computer system. The system further includes a means for controlling the set of expansion slot speed indicators based on the current operating speeds of the plurality of expansion slots.

In another exemplary embodiment, a computer system includes a set of expansion slot indicators to indicate current operating speeds of a plurality of expansion slots.

### BRIEF DESCRIPTION OF THE SEVERAL VIEWS OF THE DRAWINGS

A better understanding of the present invention can be obtained when the following detailed description of the preferred embodiment is considered in conjunction with the following drawings, in which:

FIG. 1 is a block diagram of an exemplary computer system with seven expansion input/output slots and four expansion input/output buses;

FIG. 2 is a block diagram showing an exemplary technique for indicating the current operating speeds of the expansion input/output slots of FIG. 1;

FIG. 3 is a block diagram showing an exemplary technique for generating an expansion slot speed signal based on signals from multiple PCI-X slots;

FIG. 4 is an exemplary illustration of an expansion input/output slot and multiple slot speed indicators;

FIG. 5 is a flow chart of an exemplary technique for controlling speed indicators for expansion input/output slots such as those of FIG. 1; and

FIG. 6 is a block diagram showing an exemplary use of GPIO pins in controlling expansion slot speed indicators in accordance with the technique of FIG. 5.

### DETAILED DESCRIPTION OF THE INVENTION

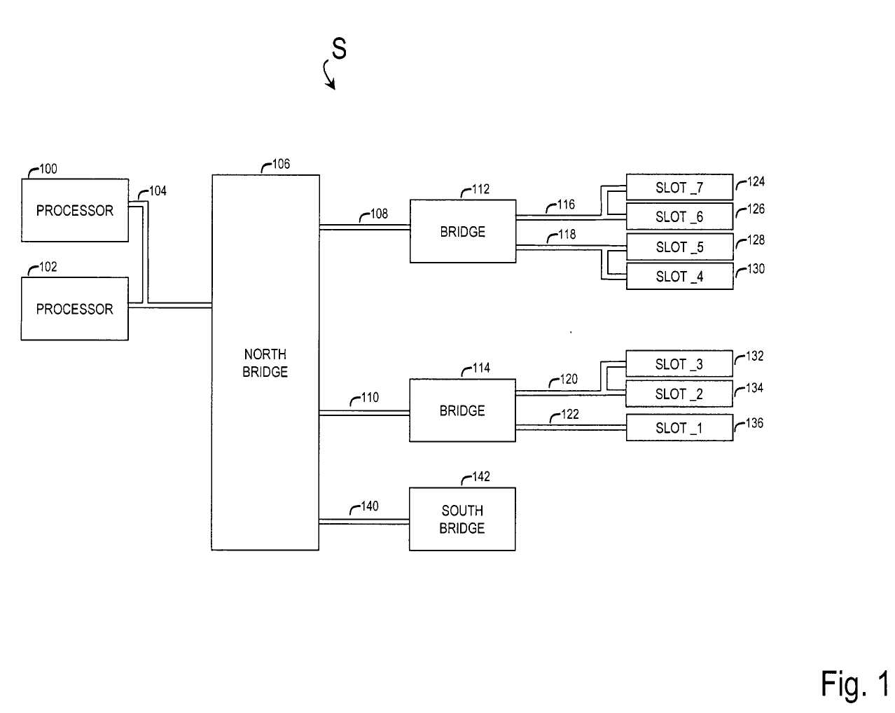

Turning now to the drawings, FIG. 1 shows an exemplary quad peer, dual-processor architecture of a computer system S. Processors 100 and 102 are connected to a bridge 106 (commonly termed a “north bridge”) through a front-side bus 104. The bridge 106 is coupled to a bridge 112 through a bus 108 and is coupled to a bridge 114 through a bus 110. The bridge 112 is coupled to an expansion bus 116 shared by expansion slots 124 and 126. Expansion slots 128 and 130 share an expansion bus 118 connected to the bridge 112. The bridge 112 thereby interfaces between the bridge 106 and the expansion slots 124-130. The bridge 114 is coupled through an expansion bus 120 to expansion slots 132 and 134. Expansion slot 136 is coupled to the bridge 114 through an expansion bus 122. The bridge 114 thereby interfaces between the bridge 106 and expansion slots 132-136. Due to the bridges 106, 112 and 114, the processors 100-102 are coupled to the expansion slots 124-136. By virtue of the expansion slots 124-136, the computer system S is highly optimized for internal expansion. The north bridge 106 is also coupled downstream through a bus 140 to a bridge 142 (commonly termed a “south bridge”). It should be understood that the computer system of FIG. 1 is only illustrative of the architectural complexity of certain computer systems and is not intended to imply any architectural limits. Further, certain typical components have been omitted from FIG. 1 for sake of clarity.

If a PCI-X architecture is desired, the computer system S of FIG. 1 can be a PCI-X 1.0 compliant server. An example of a suitable processor for processors 100 and 102 is the Intel® Xeon processor. Rather than dual processing as shown in FIG. 1, the computer system S can alternatively provide only a single processor. Expansion slots 124-130 are implemented as 64-bit/100-MHz PCI-X Hot Plug slots, and expansion slots 132-136 are implemented as 64-bit/100-MHz PCI-X Non-Hot Plug slots. PCI Hot Plug technology is currently defined in the PCI Hot-Plug Specification, Revision 1.0. Expansion buses 116-122 are 64-bit/100-MHz PCI-X buses, and bridges 112-114 are PCI-X bridges. The processors 100 and 102, front-side bus 104, bridge 106, buses 108-110 and bridges 112-114 are each part of an integrated system input/output (I/O) chipset such as the Grand Champion(GC)-HE chipset available from ServerWorks Corporation, a subsidiary of Broadcom Corporation. Alternatively, other system I/O solutions can be employed. This PCI-X 1.0 compliant server is illustrative of the PCI/PCI-X architectural complexity confronting users.

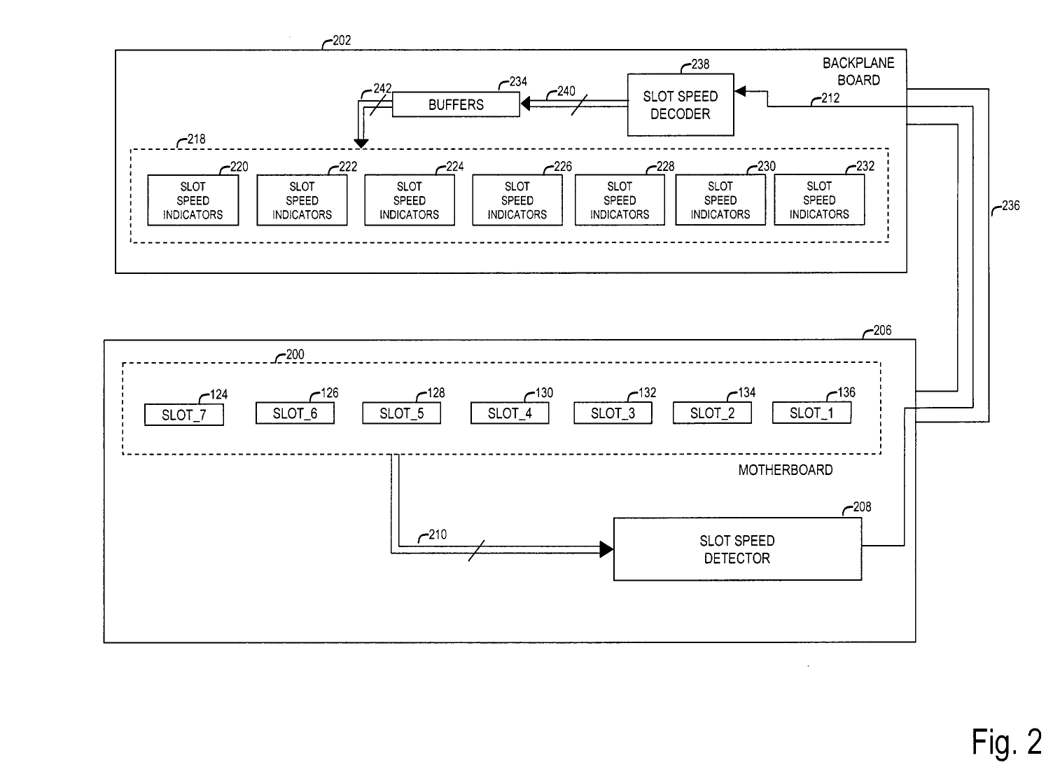

Referring to FIG. 2, an exemplary technique for indicating the current operating speeds of expansion slots 200 to a user is shown. Two circuit boards of the computer system S are included in FIG. 2: a motherboard 206 and a backplane board 202. Signals 210 are provided from the expansion slots 200 on the motherboard 206 to a slot speed detector 208 also on the motherboard 206. These signals 210 can be timing, status or other signals of use in identifying the current operating speeds of the expansion slots 200. The signals 210 can include a group of signals for each expansion slot 124-136 or alternatively a group of signals for each of expansion buses 116-122 (FIG. 1). Based on the signals 210, the slot speed detector 208 detects or determines the current operating speeds of each of the expansion slots 200. It should be understood that expansion slots on the same expansion bus generally run at the same operating speed.

The slot speed detector 208 also serves as an encoder by encoding the signals 210 into an expansion slot speed signal 212 representing the current operating speeds of each of the expansion slots 200. This can be accomplished by using the slot speed detector 208 as a serial shift chain or a parallel-to-serial converter that converts or combines the signals 210 into the expansion slot speed signal 212. One advantage of this approach is reducing the number of pins or signals involved in communicating the current operating speeds of the expansion slots 200 to the backplane board 202. The slot speed detector 208 can be implemented with a programmable logic device such as the CY37256VP256 available from Cypress Semiconductor Corporation, for- example. It should be understood that various forms of logic other than a serial shift chain or a parallel-to-serial converter can be used in implementing the slot speed detector 208.

The expansion slot speed signal 212 is provided through a cable 236 extending between the motherboard 206 and the backplane board 202 to a slot speed decoder 238 which converts or decodes the expansion slot speed signal 212 into multiple expansion slot speed signals 240, such as one signal for each of expansion slot indicators 218. The slot speed decoder 238 can be implemented as a serial-to-parallel shift register. An example of a suitable shift register is a register of the type 74V594A such as the SN54LV594A available from Tex. Instruments. The expansion slot speed signals 240 contain information as to the current operating speeds of each expansion slot of the expansion slots 200. If the number of signal lines used in communicating the slot speed information for controlling the slot speed indicators 218 is not a significant issue, then the slot speed detector 208 and the slot speed decoder 238 can likely be eliminated or replaced with a single logic device to control the slot speed indicators 218. If utilized, the slot speed detector 208 and the slot speed decoder 238 together control the slot speed indicators 218.

Buffers 234 are shown coupled between the slot speed decoder 238 and the slot speed indicators 218. These buffers 234, which amplify the expansion slot speed signals 240 to produce the expansion slot speed signals 242, are useful for ensuring that the slot speed decoder 238 is not overstressed and the slot speed indicators 218 are not underdriven. If the slot speed indicators 218 are underdriven, the slot speed indicators 218 may be less effective in indicating the current operating speeds of the expansion slots 200 to a user. If the slot speed decoder 238 is overstressed, then the slot speed decoder 238 may become unable to drive enough current to operate the slot speed indicators 218 correctly. 74LVC244 buffers available from Phillips Semiconductor are suitable for implementing the buffers 234. In an alternative embodiment, the slot speed decoder 238 can drive the slot speed indicators 218 directly without use of any buffering. Though not shown, a clock line and a load line can be used in driving the slot speed decoder 238.

As can be seen in FIG. 2, within the slot speed indicators 218, there is a separate group of slot speed indicators 220-232 for each of the seven expansion slots 124-136. More particularly, slot speed indicators 220 indicate the current operating speed of expansion slot 124 (Slot_{—}7); slot speed indicators 222 indicate the current operating speed of expansion slot 126 (Slot_{—}6); slot speed indicators 224 indicate the current operating speed of expansion slot 128 (Slot_{—}5); slot speed indicators 226 indicate the current operating speed of expansion slot 130 (Slot_{—}4); slot speed indicators 228 indicate the current operating speed of expansion slot 132 (Slot_{—}3); slot speed indicators 230 indicate the current operating speed of expansion slot 134 (Slot_{—}2); and slot speed indicators 232 indicate the current operating speed of expansion slot 136 (Slot_{—}1). Each of the slot speed indicators 220-232 can be a series of indicator lights such as light-emitting diodes (LEDs) designed to emit visible light. If LEDs are used, they can each be of the same color (green, for instance) or different colors, depending on what approach enables users to more easily identify the current operating speeds of the expansion slots 124-136. As an alternative to indicator lights, the slot speed indicators 220-232 may indicate or visually represent or communicate current operating speeds of expansion slots 124-136 to a user in other ways. Each of the slot speed indicators 220-232 can be located proximate or in close proximity to its corresponding expansion slot 124-136 without being proximate or in close proximity to any other expansion slot 124-136. For instance, the backplane board 202 can be positioned in close proximity to the motherboard 206 with each of expansion slots 124-136 aligned with its corresponding indicator of slot speed indicators 220-232. Thus, due to slot speed indicators 218, a user can readily determine and distinguish the current operating speed of any of the expansion slots 124-136.

The slot speed indicators 218 also can help to avoid user confusion as to current operating speeds of expansion slots 200. As a whole, the slot speed indicators 218 provide a real time slot-by-slot indication of the current operating speeds of the expansion slots 200. As such, a user is better able to identify a performance issue based on the expansion slots 200 or the adapter cards therein. If the slot speed indicators 218 indicate an incorrect operating speed for any of expansion slots 200, then the user quickly knows where to focus his or her troubleshooting efforts. The expansion slot speed indicators 208 thus can significantly reduce the time and work involved in addressing performance issues. It should be understood that if a particular expansion slot will be uninstalled, a designer may elect to not provide speed indicators for the expansion slot.

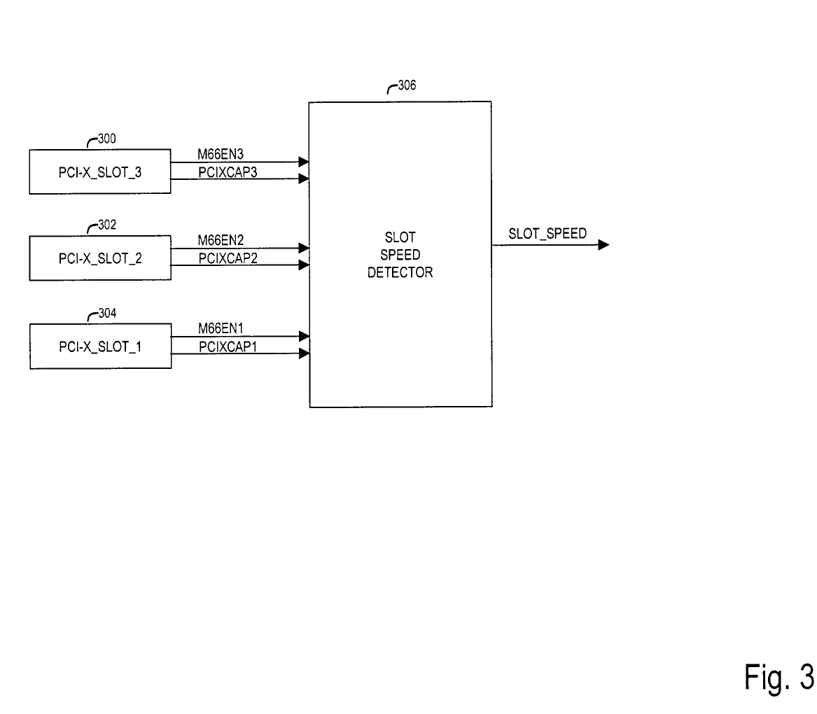

Referring to FIG. 3, an exemplary technique for generating an expansion slot speed signal is shown. The expansion slots in this example are three PCI-X slots 300-304. For each of PCI-X slots 300-304, two types of PCI-X signals are provided to a slot speed detector 306, which is of like structure and function to the slot speed detector 208, for use in detecting the speed of the PCI-X slots 300-304. For PCI-X slot 300 (PCI-X_SLOT_{—}3), M66EN3 and PCIXCAP3 signals are provided. Similarly, for PCI-X slot 302 (PCI-X_SLOT_{—}2), M66EN2 and PCIXCAP2 signals are provided. For PCI-X slot 304 (PCI-X_SLOT_{—}1), M66EN1 and PCIXCAP1 signals are provided. M66EN3, M66EN2 and M66EN1 signals are M66EN signals as currently defined in the PCI-X Addendum to the PCI Local Bus Specification, Revision 1.0. Similarly, PCIXCAP3, PCIXCAP2 and PCIXCAP1 signals are PCIXCAP signals as defined in the same addendum. The PCIXCAP3-PCIXCAP1 and M66EN3-M66EN1 signals are useful in distinguishing a 33 MHz speed, 66 MHz speed and 133 MHz speed.

The slot speed signal SLOT_SPEED generated by the slot speed detector 306 contains the information from the six input signals to the slot speed detector 306 in one signal. If PCI-X slots 300-304 were each on the same expansion bus, it would be sufficient for only a single pair of M66EN and PCIXCAP signals to be provided to the slot speed detector 306. It should further be understood that the signals shown in FIG. 3 are only exemplary of the possible signals which can be used to determine the speed of PCI-X slots 300-304.

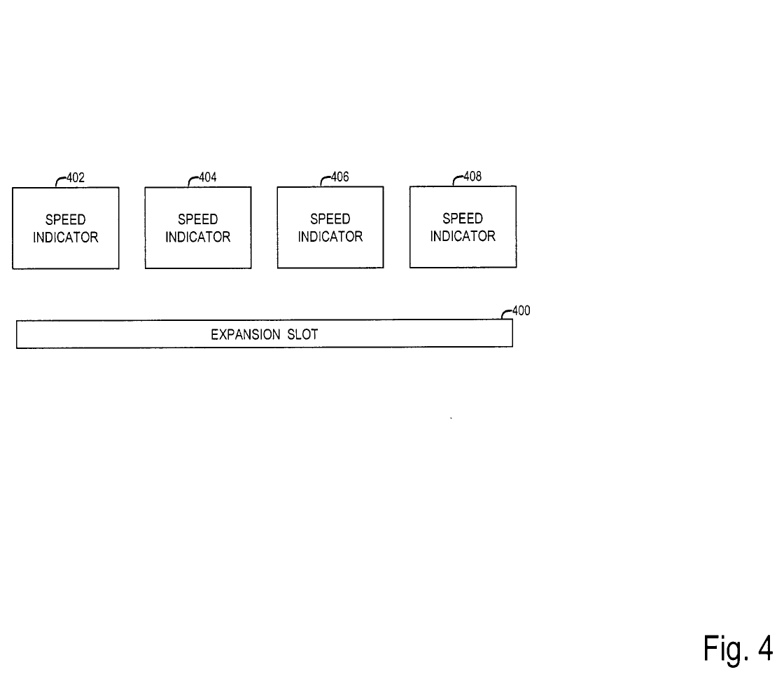

Referring to FIG. 4, an exemplary expansion slot 400 and exemplary speed indicators 402-408 are shown. The speed indicators 402-408 are located proximate or in close proximity to the expansion slot 400 so that a user can visually associate the speed indicators 402-408 with the corresponding expansion slot 400. For instance, the speed indicators 402-408 can be located at a position directly above the corresponding expansion slot 400. By viewing the speed indicators 402-408, a user can quickly and easily determine the current operating speed of the expansion slot 400.

One approach to using the speed indicators 402-408 is where each speed indicator 402-408 represents a different operating speed of the expansion slot 400. For example, if the speed indicator 402 is active, then the current operating speed of the expansion slot 400 is 33 MHz. If the speed indicator 404 is active, then the current operating speed of the expansion slot 400 is 66 MHz. If the speed indicator 406 is active, then the current operating speed of the expansion slot 400 is 100 MHz. If the speed indicator 408 is active, then the current operating speed of the expansion slot 400 is 133 MHz. Thus, with this approach, the slowest operating speed is in the leftmost speed indicator position and the fastest operating speed is in the rightmost speed indicator position. Though the slot speed indicators 402-408 are shown horizontally, slot speed indicators are by no means limited to such an arrangement. For example, the slot speed indicators 402-408 can instead be arranged vertically. Each speed indicator 402-408 can be implemented as an indicator light that is lit when active.

Under another approach, slot speed indicators 402-408 are used to indicate both the current operating speed of the expansion slot 400 and whether the adapter card in the expansion slot 400 is a PCI or PCI-X adapter card. If the speed indicator 408 is active, then the current operating speed of the expansion slot 400 is 100 MHz and the adapter card in the slot 400 is a PCI-X card. If the speed indicator 402 is active, then the current operating speed of the expansion slot 400 is 33 MHz and the adapter card in the slot 400 is a PCI card. If the speed indicator 404 is active, then the current operating speed of the expansion slot 400 is 66 MHz and the adapter card in the slot 400 is a PCI card. If the speed indicator 406 is active, then the current operating speed of the expansion slot 400 is 66 MHz and the adapter card in the slot 400 is a PCI-X card. Therefore, if either the speed indicator 404 or the speed indicator 406 is active, then the current operating speed of the expansion slot 400 is 66 MHz. The speed indicators 404-406 also help to indicate if the adapter card in the slot 400 is a PCI or PCI-X card since both 66 MHz PCI cards and 66 MHz PCI-X cards exist. This type of information is useful since a PCI-X card has certain performance enhancements over a PCI card even if the PCI-X card and the PCI card operate at the same frequency. Thus, expansion slot indicators as disclosed herein are not limited to indicating the current operating speed of an expansion slot, but rather can additionally or alternatively indicate other performance parameters (e.g., type or bitsize) of an expansion slot.

Approaches to using speed indicators where each speed indicator does not represent a different operating speed are also possible. One such approach is to use the number of active speed indicators to represent the current operating speed of the expansion slot 400. For example, if only the speed indicator 402 is active, then the current operating speed of the expansion slot 400 is 33 MHz. If only the speed indicators 402 and 404 are active, then the current operating speed of the expansion slot 400 is 66 MHz. If only the speed indicators 402-406 are active, then the current operating speed of the expansion slot 400 is 100 MHz. If all of speed indicators 402-408 are active, then the current operating speed of the expansion slot 400 is 133 MHz.

It should be understood that speed indicators can be active for a predetermined period of time sufficient to allow a user to determine the current operating speeds of the expansion slots, rather than having the speed indicators active throughout normal operation of the computer system. It should further be understood that the number of speed indicators shown in FIG. 4 is only illustrative as the number of speed indicators utilized may take into account a variety of factors such as the number of possible operating speeds of an expansion slot and the maximum number of speed indicators which a user is likely to be comfortable viewing. Also, like the expansion slot 400 in FIG. 4, each expansion slot 124-136 in FIG. 2 can be associated with multiple speed indicators. It should further be understood that a single group of speed indicators can be used for expansion slots on the same expansion bus in an alternative embodiment, rather than providing a group of speed indicators for each expansion slot.

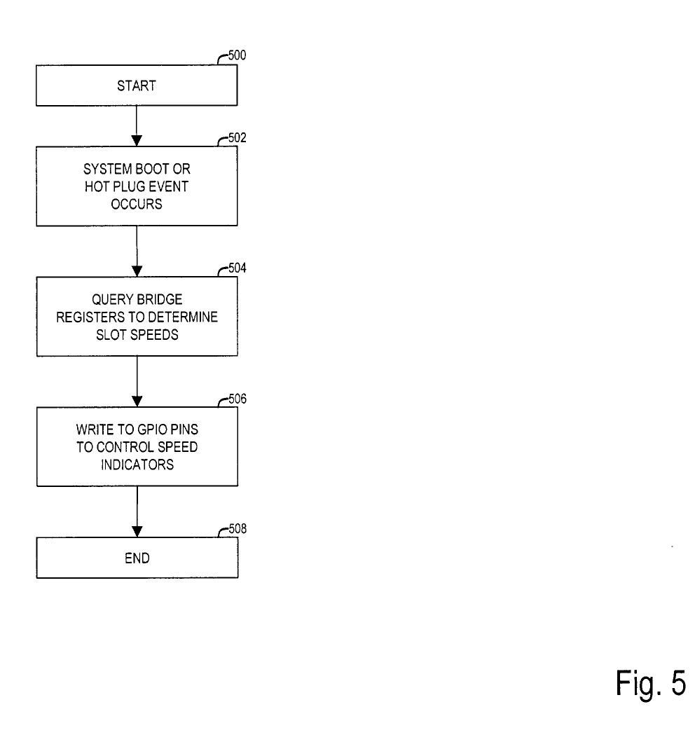

Referring to FIG. 5, an exemplary technique for controlling expansion slot speed indicators begins in step 500. Next, in step 502, it is determined whether the computer system S has been booted or whether a Hot Plug event, such as removal of an adapter card from an expansion slot and/or addition of an adapter card to an expansion slot, has occurred for the computer system S. Both system conditions represent circumstances when a user may wish to know the operating speed of the expansion slots in the computer system S. Alternatively, in step 502, it can simply be determined when an expansion slot is populated or re-populated or when the computer system S is reset. The technique proceeds from step 502 to step 504 where the appropriate registers in bridges 112 and 114 are queried to detect the operating speeds of the expansion slots 124-136 in the computer system S. If bridges 112 and 114 are PCI-X bridges, then the signals read from the registers can be of the same sort as the M66EN and PCIXCAP signals described above and in the PCI-X Addendum to the PCI Local Bus Specification, Revision 1.0.

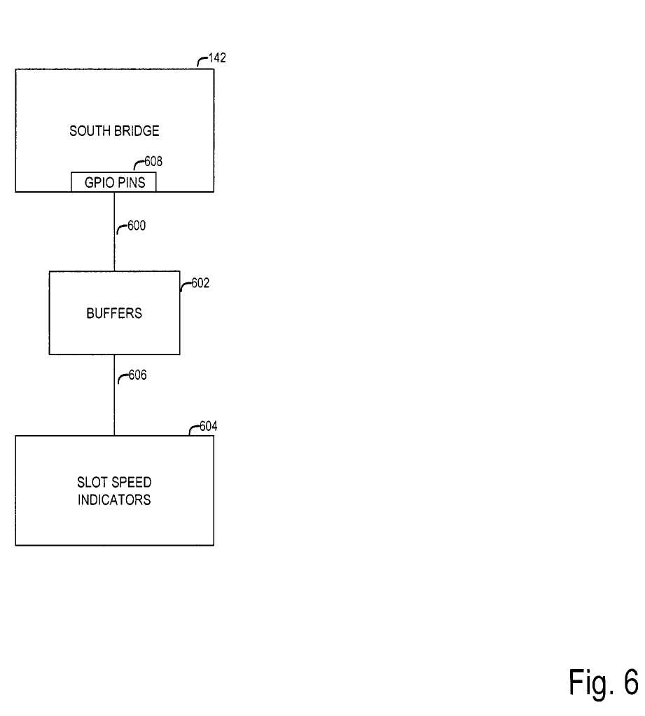

Following step 504, the technique advances to step 506 where general purpose input/output (GPIO) pins 608 (FIG. 6) of the south bridge 142 are written based on the expansion slot operating speeds determined in step 504. Referring to FIG. 6, GPIO pin signals 600 from GPIO pins 608 are routed to optional buffers 602 which provide buffered signals 606 to drive expansion slot speed indicators 604. Buffers 602 are of like structure and function to the buffers 234 of FIG. 2. Similarly, expansion slot speed indicators 604 are of like structure and function to the expansion slot speed indicators 218 of FIG. 2 and the expansion slot speed indicators 402-408 of FIG. 4. The GPIO pins 608 basically help to control the expansion slot speed indicators 604. Returning to FIG. 5, Steps 502-506 described above can be performed by software within the computer system S. The term “software” as used herein is inclusive of firmware. The technique of FIG. 5 ends in step 508. From the disclosure herein, it should be appreciated that expansion slot speed indicators can be controlled through hardware like described in connection with FIG. 2 and/or software like described in connection with FIGS. 5 and 6.

The foregoing disclosure and description of various embodiments are illustrative and explanatory thereof, and various changes in the bridges, buses, buffers, signals, logic, expansion slots, adapter cards, indicator lights, PCI/PCI-X protocol, operating speeds, speed indicators, speed detectors, and speed decoders, as well as the details of the illustrated hardware and software and construction and method of operation may be made without departing from the spirit and scope of the invention.

I claim:

1. A computer system, comprising:
a processor;
a plurality of expansion slots coupled to the processor;
a speed detector to detect current operating speeds of the plurality of expansion slots; and
a set of expansion slot speed indicators to indicate the current operating speeds of the plurality of expansion slots.

2. The computer system of claim 1, wherein the set of expansion slot speed indicators visually indicates the current operating speeds of the plurality of expansion slots.

3. The computer system of claim 1, wherein the set of expansion slot speed indicators comprises a set of indicator lights.

4. The computer system of claim 3, wherein the set of indicator lights comprises a set of light emitting diodes.

5. The computer system of claim 1, wherein the set of expansion slot speed indicators comprises a separate plurality of expansion slot speed indicators visually associated with each expansion slot of the plurality of expansion slots.

6. The computer system of claim 5, wherein each expansion slot speed indicator of the plurality of expansion slot speed indicators represents a different operating speed.

7. The computer system of claim 1, wherein the plurality of expansion slots comprises a plurality of Peripheral Component Interconnect (PCI-X) slots.

8. The computer system of claim 1, wherein the speed detector comprises a programmable logic device.

9. The computer system of claim 1, wherein the plurality of expansion slots are contained on a first circuit board in close proximity to a second circuit board containing the set of expansion slot speed indicators.

10. A method, comprising the steps of:
detecting a current operating speed of an expansion slot of a computer system; and
indicating the current operating speed of the expansion slot at a location proximate to the expansion slot.

11. The method of claim 10, wherein the indicating step comprises the step of visually indicating the current operating speed of the expansion slot.

12. The method of claim 10, wherein the indicating step comprises the step of emitting visible light to indicate the current operating speed of the expansion slot.

13. The method of claim 10, further comprising the step of:
performing the detecting and indicating steps for a plurality of expansion slots of the computer system.

14. The method of claim 10, wherein the computer system comprises a server.

15. A system, comprising:
a means for detecting a current operating speed of an expansion slot of a backplane of a computer system;
a means for generating an expansion slot operating speed signal based on the current operating speed of the expansion slot; and
a means for providing the expansion slot operating speed signal to the backplane.

16. The system of claim 15, further comprising:
a means for indicating the current operating speed of the expansion slot based on the expansion slot operating speed signal received from the means for providing.

17. The system of claim 16, the means for indicating comprising:
an indicator light to indicate the current operating speed of the expansion slot.

18. The system of claim 15, wherein the means for generating comprises a programmable logic device.

19. The system of claim 15, further comprising:
a means for detecting the current operating speed of each expansion slot of a plurality of expansion slots of the backplane;
a means for generating a combined expansion slot operating speed signal based on the current operating speed of each expansion slot of the plurality of expansion slots; and
a means for providing the combined expansion slot operating speed signal to the backplane.

20. The system of claim 19, further comprising:
a means for indicating the current operating speed of each expansion slot of the plurality of expansion slots based on the combined expansion slot operating speed signal received from the means for providing.

21. A system, comprising:
a set of expansion slot speed indicators to indicate a current operating speed of each expansion slot of a plurality of expansion slots of a computer system; and
a means for controlling the set of expansion slot speed indicators based on the current operating speed of each expansion slot of the plurality of expansion slots.

22. The system of claim 21, the means for controlling comprising:
a means for generating an expansion slot operating speed signal based on the current operating speed of each expansion slot of the plurality of expansion slots.

23. The system of claim 21, the means for controlling comprising:
a means for selectively detecting the current operating speed of each expansion slot of the plurality of expansion slots.

24. The system of claim 23, the means for selectively detecting comprising:
a means for detecting the current operating speed of each expansion slot of the plurality of expansion slots in response to the computer system booting.

25. The system of claim 23, the means for selectively detecting comprising:
a means for detecting the current operating speed of each expansion slot of the plurality of expansion slots in response to a Hot Plug event of the computer system.

26. A computer system, comprising:
a set of expansion slot speed indicators to indicate current operating speeds of a plurality of expansion slots.

27. The system of claim 26, further comprising:
the plurality of expansion slots.

28. The system of claim 26, further comprising:
a means for controlling the set of expansion slot speed indicators.
